(19) United States
(12) Patent Application Publication
(10) Pub. No.: US 2003/0115448 A1
(43) Pub. Date: Jun. 19, 2003

(54) Methods and apparatus for securely communicating a message

(76) Inventor: Thaddeus Bouchard, Andover, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/282,932

(22) Filed: Oct. 29, 2002

Related U.S. Application Data
(60) Provisional application No. 60/351,150, filed on Oct. 29, 2001.

(51) Int. Cl. H04L 9/00

(52) U.S. Cl. 713/153

(57) ABSTRACT

The invention relates to methods and apparatus for securely communicating a message between a first communication module and a second communication module. The first communication module receives a first message generated by a user. A secure message routing module is in communication with the first communication module to automatically encrypt the first message to create a final encrypted message. The final encrypted message can only be decrypted by a particular receiver. The automatic encryption that the secure message routing module performs is transparent to the user.

### CROSS REFERENCE TO RELATED APPLICATIONS

This application claims priority to U.S. provisional patent application serial No. 60/351,150, filed Oct. 29, 2001. The provisional application serial No. 60/351,150 is incorporated by reference herein.

### FIELD OF THE INVENTION

The present invention relates generally to the delivery of digital information, and particularly to the secure communication of a message between a first communication module and a second communication module.

### BACKGROUND OF THE INVENTION

Over the past few decades, the techniques and electronic devices enabling two parties to communicate with each other have experienced rapid and perhaps unforeseen advances. The most notable advance has been the establishment of global communication networks, such as the Internet or World Wide Web (i.e., web). The existence of such global communication networks affords individuals and corporations the ability to communicate over great distances at a nominal cost.

Further, parties communicating over the Internet (or any global network) typically enjoy flexible delivery of communications. For example, the Internet traditionally enables the communication of any type of data. In particular, one party may transmit a picture over the Internet, such as a .JPEG file, via an e-mail message. The other party may transmit an audio file over the Internet, such as a .WAV file.

As a result of the many benefits that a global network provides, the use of the Internet has seen possibly unrivaled expansion since its inception. Companies often conduct business by sending and receiving business documents over the Internet. For example, a company may send a contract, a memorandum, a price list, a business model, or a presentation over the Internet. Moreover, individuals often socialize over the Internet, such as through e-mail and instant messaging.

Despite the many advantages associated with the Internet, the Internet also has several shortcomings. One of these drawbacks is the security of its communications. For example, a message may pass through multiple computers before arriving at its destination when delivered over the Internet. Some or all of these computers can be insecure, enabling potential interception of the message. The interception of a message may result in unauthorized access to the message, creation of another copy of the message, and/or modification of the message. Any or all of these security breaches may result in a business or individual experiencing, for example, embarrassment, financial losses, loss in status or reputation, and/or loss in trustworthiness.

Several techniques have been developed to overcome the security pitfall of the Internet, such as cryptography. This traditionally involves encrypting a message being sent and decrypting a message that is received. The encryption and decryption can occur through the use of a digital certificate. A digital certificate is typically what ties an identity, for example a name or e-mail address, with a public key. The public key is a unique number used in encryption.

The conventional problem with using cryptographic techniques is that a user must play an active role in encrypting a message being sent and decrypting a message that is received. For example, a sender of the message, such as user A, typically has to retrieve a digital certificate from a certificate authority (CA). Moreover, user A has to specify that the e-mail is secure when transmitting the e-mail to a recipient, such as user B. To specify security, user A has to click on a “Security” button or other software flag of the software program used to send the message. If user A does not have the user B's digital certificate, however, user A typically cannot encrypt the e-mail being sent to user B.

If user A receives a message from user B, user A may want to verify that the message came from user B and not an unknown party. User B may facilitate this verification by, for instance, clicking a “Signed” dialog box on the software program that received the message.

The implementation of encryption technology for security purposes typically requires the user to perform steps in addition to the normal procedures used to send and receive a message. Thus, there is a need to reduce the complexity of secure communications over the Internet and facilitate such communications without relying on a user's actions.

### SUMMARY OF THE INVENTION

The invention solves the above-mentioned problems by enabling a first communication module to securely communicate a message to a second communication module without any additional steps performed by a user of either the sending module or the receiving module. In one aspect, the invention includes a method having the step of the first communication module receiving a first message. The first message can be generated by a user, which may be a person or a communication device. The method also includes the step of automatically encrypting the first message to create a final encrypted message. The final encrypted message can only be decrypted by the second communication module. This automatic encryption is transparent to the user, thereby enabling the secure communication of a message without any steps performed by the user (of the sending or receiving device) besides the usual steps to send/receive a message.

The first message may be an e-mail or any other type of message that can be communicated between the first and second communication modules. Moreover, the first message may be transmitted to the first communication module in response to a rule associated with the destination address of the first message. To create the final encrypted message, the first communication module can create a second message having the first message embedded in the second message. The first communication module may then digitally sign the second message to create a first encrypted message. This digital signature can be decrypted with the public key associated with the first communication module. The first communication module can also generate a third message having the first encrypted message embedded within the third message. The final encrypted message is created when the first communication module digitally signs the third message. The final encrypted message can only be decrypted by a particular private key.

Additionally, the method may include the step of decrypting the final encrypted message before transmitting the decrypted message to the proper recipient. Similar to the encryption, the decryption is transparent to the recipient.

In another aspect, the invention relates to an apparatus for securely communicating a message. The apparatus comprises a first communication module and a first secure message routing module. The first communication module receives a first message generated by a user. The first secure message routing module automatically encrypts the first message to create a final encrypted message so that only a particular receiver of the final encrypted message can decrypt the final encrypted message. Moreover, the automatic encryption is transparent to the user.

The first communication module may be a server, such as a master e-mail server. Further, the particular receiver of the final encrypted message may be a second secure message routing module, such as on a client computer or satellite e-mail server. Moreover, the particular receiver may be the module that decrypts the message before transmitting the message to the intended recipient.

The second secure message routing module may include a relay module, a secure reply module, and/or a message submit module. The relay module can enable the second secure message routing module to receive the final encrypted message from the first communication module. Furthermore, the secure reply module can enable sending a secure reply message to the first communication module in response to the final encrypted message. The message submit module can enable a new message addressed to a recipient to be transmitted to the first communication module for security processing before transmitting to the recipient.

In another aspect, the invention relates to a method for securely communicating a message between a first communication module and a second communication module. The method includes the step of receiving a first encrypted message sent by a first user. The first communication module receives the first encrypted message. The method also includes the step of receiving a second message generated by a second user. The first communication module receives the second message. The first user is in communication with the second communication module, while the second user is in communication with the first communication module. The method additionally includes the step of automatically decrypting the final encrypted message to obtain a first message addressed to the second user. Moreover, the second message is automatically encrypted to create a second encrypted message so that only the second communication module can decrypt the second encrypted message. Further, the automatic encryption and the automatic decryption are transparent to the first and second users.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an embodiment of a secure message routing system.

FIG. 2 is a block diagram of an embodiment of a secure message routing system having a master e-mail server and a satellite e-mail server.

FIG. 3 is a block diagram of an embodiment of the flow of an e-mail message before being sent to the master e-mail server for subsequent delivery to the satellite e-mail server.

FIG. 4 is a flow diagram illustrating an embodiment of the steps performed by the secure message routing system to send the message to the master e-mail server for subsequent delivery to the satellite e-mail server.

FIG. 5 is a block diagram of an embodiment of the flow of the e-mail upon processing by the master e-mail server.

FIG. 6 is a flow diagram illustrating an embodiment of the steps performed by the master e-mail server to send the e-mail message to the satellite e-mail server.

FIG. 7 is a flow diagram of an embodiment of the steps performed by the satellite e-mail server upon receipt of a message from the master e-mail server.

FIG. 8 is a block diagram of an embodiment of a secure message routing module of the secure message routing system.

FIG. 9 is a more detailed flow diagram illustrating an embodiment of the steps performed by the satellite e-mail server upon receipt of a message from the master e-mail server.

FIG. 10 is a flow diagram illustrating an embodiment of the steps performed by a message submit module of the satellite e-mail server to enable a user to securely send a message to a recipient.

### DETAILED DESCRIPTION

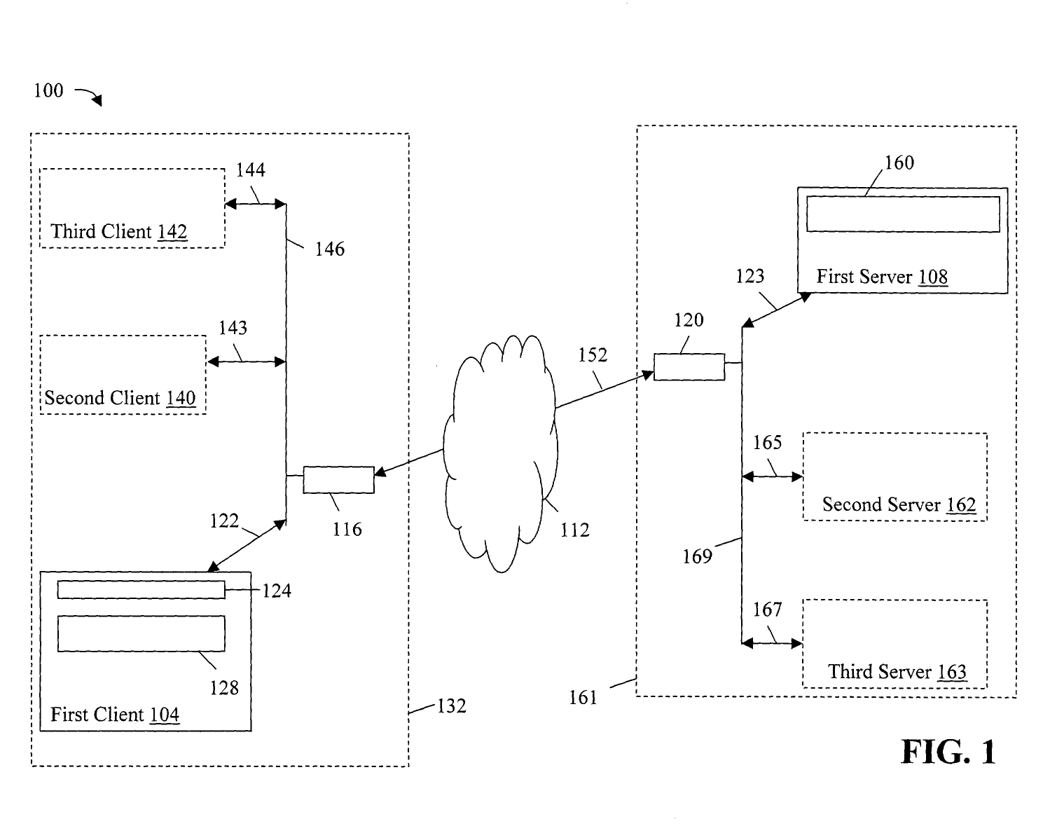

Referring to FIG. 1, a secure message routing system 100 is a system that includes a first client computer (“client”) 104 in communication with a first server computer (“server”) 108 over a network 112. The client 104 communicates with a client router 116 to deliver and receive messages over the network 112. Likewise, the server 108 communicates with a server router 120 to deliver and receive messages over the network 112. A message may be an e-mail, a download or upload, an alarm, or any other type of communication between two devices.

The client 104 can be any device capable of communicating over the network 112. For example, the client 104 may be a personal computer (e.g., based on a microprocessor from the 680x0 family, PowerPC, PA-RISC, MIPS families, an Intel microprocessor, an Advanced Micro Devices microprocessor), smart or dumb terminal, network computer, wireless device, information appliance, workstation, minicomputer, or mainframe computer. Operating systems supported by the client 104 can include any member of the WINDOWS family of operating systems from Microsoft Corporation of Redmond, Wash., Macintosh operating system, JavaOS, and various varieties of Unix (e.g., Solaris, SunOS, Linux, HP-UX, A/IX, and BSD-based distributions).

The routers 116, 120 may be any device that can direct messages to and from the network 112, such as a router, firewall, gateway, or relay. Additionally, the client router 116 communicates with the client 104 over a first client-router communication channel 122. Moreover, the server router 120 communicates with the server 108 over a first server-router communication channel 123.

The client 104 can also include a web browser 124 to communicate with the server 108 over the network. For instance, the web browser 124 may be INTERNET EXPLORER® developed by Microsoft Corporation in Redmond, Wash. or NETSCAPE NAVIGATOR® developed by Netscape Communications Corporation of Mountain View, Calif.

Additionally, the client 104 includes a secure message routing module 128. Examples of the secure message routing module 128 include an independent computer or a software module executing on the client 104. The secure message routing module 128 provides security and stability to messages transmitted from the client 104 to the server 108. In one embodiment, the secure message routing module 128 prevents modification of a message. Additionally, the secure message routing module 128 also enables seamless integration of securely transmitting and receiving messages. This integration therefore enables a user to send and receive a message in the typical manner. Thus, the secure communication of a message between the first client 104 and the first server 108 is transparent to the procedures performed by a user. Examples of the secure message routing module 128 include an independent computer or a software module executing on the client 104. Examples of the secure message routing module 128 include an independent computer or a software module executing on the client 104.

The client 104 and the client router 116 may be part of a client network 132. The client network 132 can also include any number of additional clients, such as a second client 140 and a third client 142. In particular, the second client 140 can communicate with the client router 116 over a second client-router communication channel 143. Moreover, the third client 142 can communicate with the client router 116 over a third client-router communication channel 144. In one embodiment, the client-router communication channels 122, 143, 144 connect to a main client-router communication channel 146. Thus, the second and third clients 140, 142 can communicate with each other using the main client-router communication channel 146.

The second and third clients 140, 142 can also have an associated web browser and may communicate over the network 112 via the client router 116. Examples of the second and third client 140, 142 include an e-mail content server, an e-mail exchange server developed by Microsoft Corporation of Redmond, Wash., or a desktop computer operated by a user. Additionally, although the secure message routing module 128 is described above and below with respect to the first client 104, the description may equally apply to any of the other clients 140, 142.

The client 104 may communicate with the server 108 over the network 112. The network 112 can be a local-area network (LAN), a wide area network (WAN), or a network of networks such as the Internet or the Web. In particular, the client 104 may use the client router 116 to communicate with the server router 120 over a client-server communication channel 152 that passes through the network 112. Example embodiments of the client-server communication channel 152 includes standard telephone lines, LAN or WAN links (e.g., T1, T3, 56 kb, X.25), broadband connections (ISDN, Frame Relay, ATM), and wireless connections. The connections over the client-server communication channel 152 can be established using a variety of communication protocols (e.g., HTTP, HTTPS, TCP/IP, IPX, SPX, NetBIOS, Ethernet, RS232, messaging application programming interface (MAPI) protocol, real-time streaming protocol (RTSP), real-time streaming protocol used for user datagram protocol scheme (RTSPU), the Progressive Networks Multimedia (PNM) protocol developed by RealNetworks, Inc. of Seattle, Wash., manufacturing message specification (MMS) protocol, the Secure Multi-Purpose Internet Mail Extensions (S/MIME) protocol, and direct asynchronous connections). Additionally, the communication channels 143, 144, 146 may be any of the previously described channels.

The server 108 may be a device that communicates with the client 104. The server 108 can also host one or more programs or files that the client 104 can access. For example, the server 108 may contain a web service directory enabling the advertising and providing of web services to the client 104 over the web. The server 108 may additionally (or alternatively) provide an application to the client 104. For example, the server 108 may provide a word processing program, such as Word developed by Microsoft Corporation of Redmond, Wash., to the client 104.

The server 108 also includes a secure message routing module 160. To ensure secure communications with the client 104, the secure message routing module 160 of the server 108 can communicate with the module 128 of the client 104 using digital signatures, encryption, and authentication.

The server 108 can be any of the communicating devices described for the client 104. Further, the server 108 may be a member of a server farm 161, or server network, which is a logical group of one or more servers that are administered as a single entity. In one embodiment, the server farm 161 includes multiple servers, such as a second server 162 and a third server 163. The second and third servers 162, 163 communicate over the network 112 via the server router 120. In particular, the second server 162 can communicate with the server router 120 over a second server-router communication channel 165. Moreover, the third server 163 can communicate with the server router 120 over a third server-router communication channel 167. In one embodiment, the server-router communication channels 123, 165, 167 connect to a main server-router communication channel 169. Thus, the second and third servers 165, 167 can communicate with each other using the main server-router communication channel 169.

Although FIG. 1 illustrates three servers 108, 162, 163, the server farm 161 can have any number of servers. In other embodiments, the server farm 161 is a protected network that is inaccessible by unauthorized individuals, such as corporate Intranet, Virtual Private Network (VPN), or secure extranet. Additionally, the servers making up the server farm 161 may communicate over any of the networks described above (e.g., WAN, LAN) using any of the protocols discussed.

In one embodiment, the server 108 is designated as the “master” communication device (“master server 108”). The secure message routing module 160 of the master server 108 can manage “satellite” devices. A satellite device can be any communication device, such as the first client 108, that has a secure message routing module that the master server 108 manages. The master server 108 can also “create” a satellite device, such as by downloading the requisite software to the proper computer. For example, the master server 108 can communicate with the first client 104 to download the secure message routing module 128 onto the first client 104.

If several communication devices, such as the second and third clients 140, 142, included secure message routing modules, then the master server 108 may communicate with multiple satellite devices. Further, each satellite device may not be able to communicate with the other satellite devices. Instead, the satellite device may only be able to communicate with the master server 108 used to “create” the satellite device. Thus, using the same example as above, the first client 104 may only be able to communicate with the first server 108 after the first server 108 installs the secure message routing module 128 onto the first client 104.

Although the server 108 is described above and below as having the secure message routing module 160 that transmits the messages to the secure message routing module 128 of the client 104 and is therefore the master device, any other device, such as the client 104, can be the master device. Likewise, any communication device, such as the server 108, can also be a satellite device.

Moreover, either or both secure message routing modules 128, 160 enable secure communications via automatic encryption/decryption without a user's intervention. Therefore, the user does not need to perform any actions to reap the security benefits provided by the secure message routing modules 128, 160.

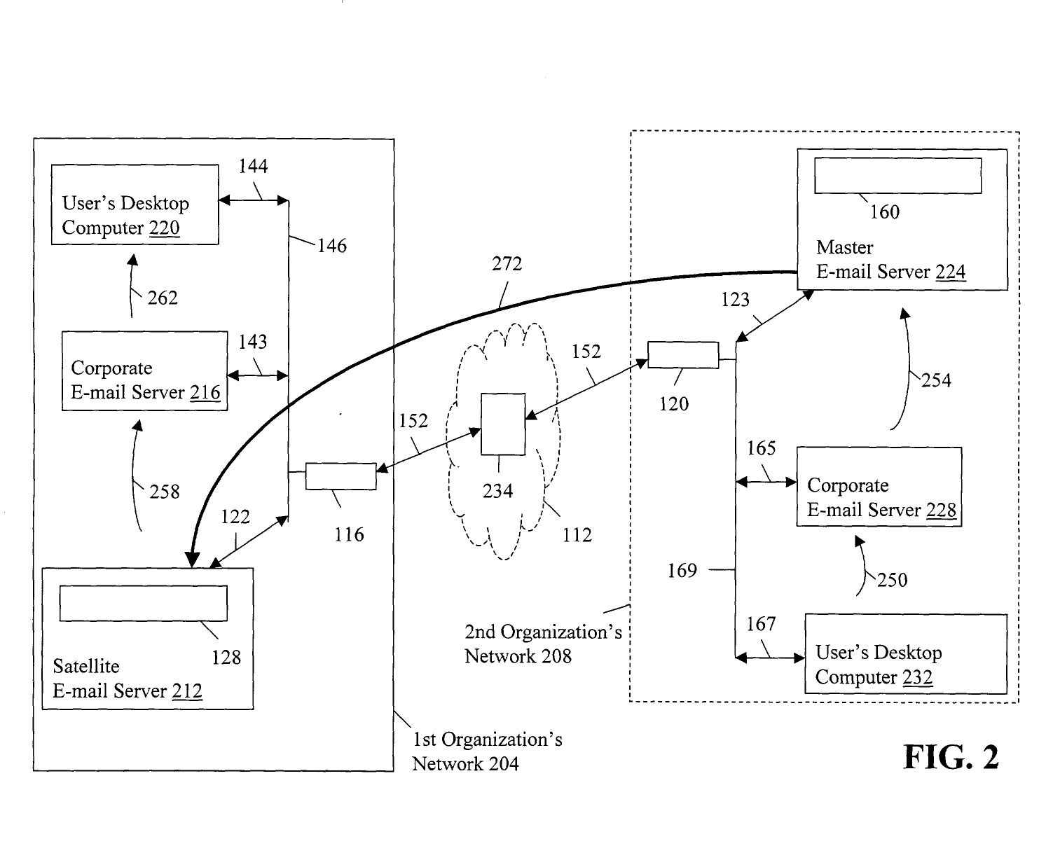

Referring to FIG. 2, an exemplary secure message routing system 200 enables the secure transmission of messages (with or without message attachments) between a first organization and a second organization. The secure message routing system 200 includes a first organization's network 204 and a second organization's network 208.

The first organization's network 204 includes a satellite e-mail server 212, a corporate e-mail server 216, and a desktop computer 220 operated by a user. Typical communications occur over the network 112 via the client router 116. The satellite e-mail server 212 includes the secure message routing module 128 and is an illustration of the first client 104. The corporate e-mail server 216, represented above as the second client 140, is a computer that typically sends and receives e-mail messages over the network 112. The desktop computer 220 (e.g., the third client 142) is a computer that can connect to the corporate e-mail server 216, such as via a modem or Digital Subscriber Line (DSL).

Similarly, the second organization's network 208 includes a master e-mail server 224 (e.g., the first server 108 above), a corporate e-mail server 228, and a desktop computer 232. The master e-mail server 224 at the second organization is configured to communicate with the satellite e-mail server 212 at the first organization. Furthermore, the corporate e-mail server 228 of the second organization (i.e., in its network 208) is configured to recognize e-mail messages that are to be sent to the first organization's network 204 and route them to the master e-mail server 224 for subsequent secure communication.

Additionally, the master e-mail server 224 and the satellite e-mail server 212 can use the Simple Mail Transfer Protocol (SMTP) to communicate e-mail messages. Moreover, the network 112 may include an SMTP server 234 to direct messages to the correct destination using the SMTP protocol.

Each secure message routing module 128, 160 can additionally have one or more configuration files that designates the message destination. Although described below in view of the secure message routing module 128 of the satellite e-mail server 212, the description can equally apply to the secure message routing module 160 of the master e-mail server 224.

The configuration file of the secure message routing module 128 of the satellite e-mail server 212 includes the address (e.g., the Domain Name Service (DNS) address) of the secure message routing module 160 of the master e-mail server 224. The configuration file can also include the address (e.g., the DNS address) of the secure message routing module 128 (e.g., the address of the satellite e-mail server 212) and the e-mail domain that the secure message routing module 128 (e.g., satellite e-mail server 212) supports. The e-mail domain that the secure message routing module 128 supports is the domain that appears in e-mail messages sent to the client or server hosting the secure message routing module 128 (e.g., the satellite e-mail server 212). Thus, if e-mails are transmitted to a user at the address of user@first organization.com, the domain that the satellite e-mail server 212 supports is first_organization.com. The configuration file may also include a challenge phrase for the installation of a digital certificate on the satellite e-mail server 212, as discussed in more detail below.

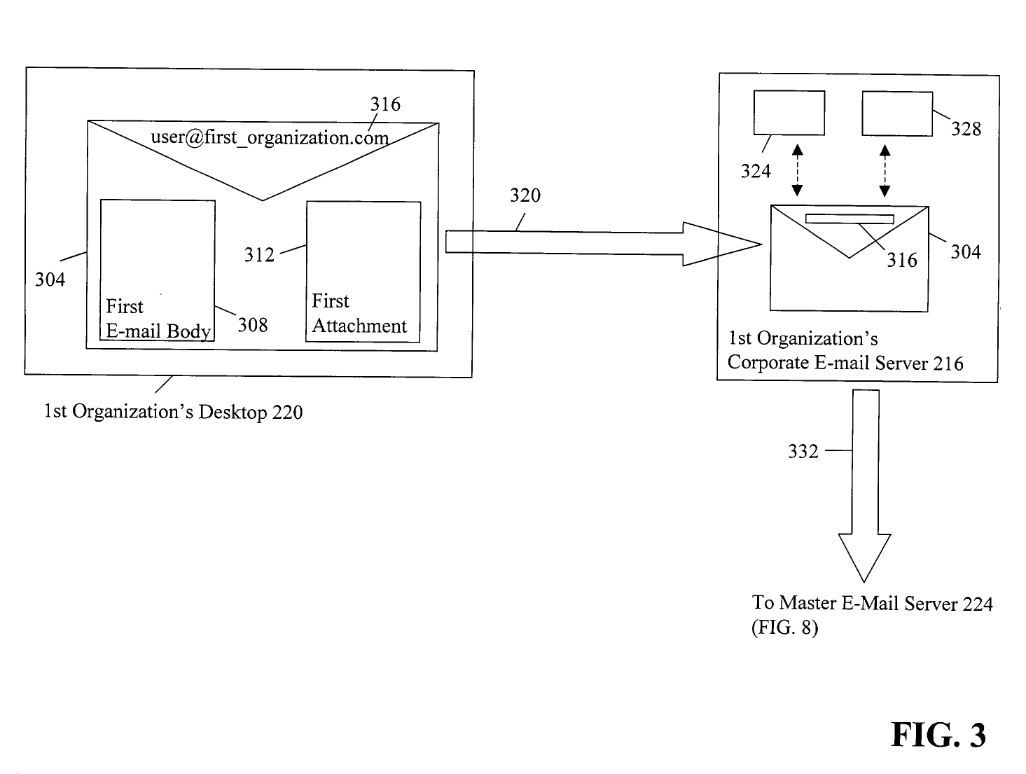

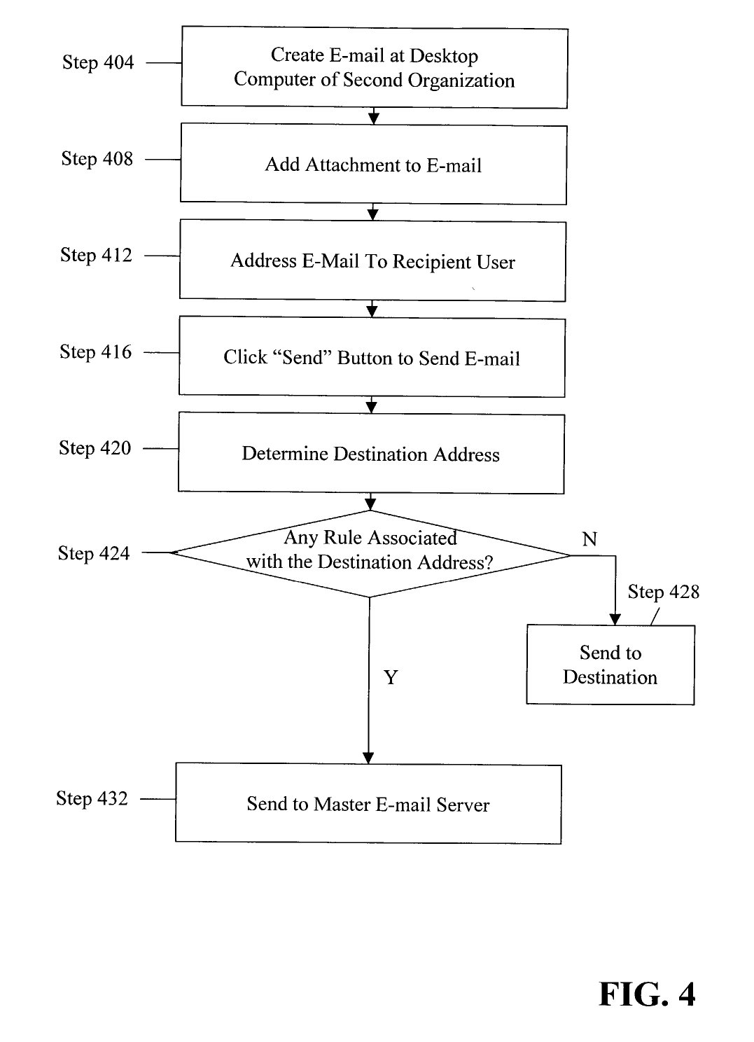

Also referring to FIG. 3 and FIG. 4, the steps taken by the secure message routing system 200 to securely communicate an e-mail message from the master e-mail server 224 in the second organization's network 208 to a destination within the first organization's network without additional user intervention (besides the typical message sending and receiving actions) are shown. The user operating the desktop 232 in the second organization's network 208 creates a first e-mail 304 having a first e-mail body 308 (STEP 404). The user may also add a first attachment 312 to the e-mail 304 (STEP 408), such as an audio file, a word processing document, a spreadsheet, a graphic, a picture, a table or chart, etc. Although illustrated with one attachment 312, any number of attachments 312 of any type of file may be added to the e-mail 304, perhaps limited by system limitations (e.g., memory limitations or bandwidth limitations).

To send the first e-mail 304 to the user operating the desktop 220 at the first organization, the master e-mail server 224 that created the first e-mail 304 addresses it to the recipient user's address 316, such as user@first organization.com (STEP 412). As with a typical e-mail, the user then clicks a button, such as a “Send” button, on the desktop software to send the message 304 (STEP 416).

The message 304 then travels to the corporate e-mail server 216 for delivery over the network 112, as shown with arrows 250 and 320. The corporate e-mail server 216 checks the recipient address 316 of the first e-mail 304 to determine the destination of the message 304 (STEP 420). Upon review of the destination address 316, the corporate e-mail server 216 determines if the recipient address user@first_organization.com matches any rules that the corporate e-mail server 216 has relating to the recipient address 316 (STEP 424).

For example, the corporate e-mail server 216 may have a recipient address table 324 that includes a list of network addresses (e.g., Internet Protocol (IP) addresses) that the corporate e-mail server 216 compares with the recipient address 316 for a match. If no address in the recipient address table 324 matches the recipient address 316, the corporate e-mail server 216 then transmits the message over the network 112 (STEP 428) to the intended recipient. If, however, the corporate e-mail server 216 finds a matching address in the recipient address table 324, the corporate e-mail server 216 then searches for a rule associated with the recipient address in a rules table 328. The tables 324, 328 may be part of the same database or may be separate databases. Moreover, the tables 324, 328 may be stored locally on the corporate e-mail server 216 or may be external to the corporate e-mail server 216.

If a rule exists that relates to the recipient address 316, the corporate e-mail server 216 executes the rule. The rule can state, for example, that all messages destined for the first organization's network 204 should be routed to the second organization's master e-mail server 224 (STEP 432). Additionally, although described above and below as a rule designating that all messages destined for the first organization's network 204 must be sent to the second organization's master e-mail server 224, the rules may state any destination for a message or any modification of the message before transmittal to any destination. Further, instead of searching through the recipient address table 324 and the rules table 328, the corporate e-mail server 216 may only compare the recipient address 316 to the rules table 328 to determine if a rule exists that is associated with the recipient address 316. The corporate e-mail server 216 then sends the first message 304 to the master e-mail server 224 (STEP 436), as shown with arrows 254 and 332.

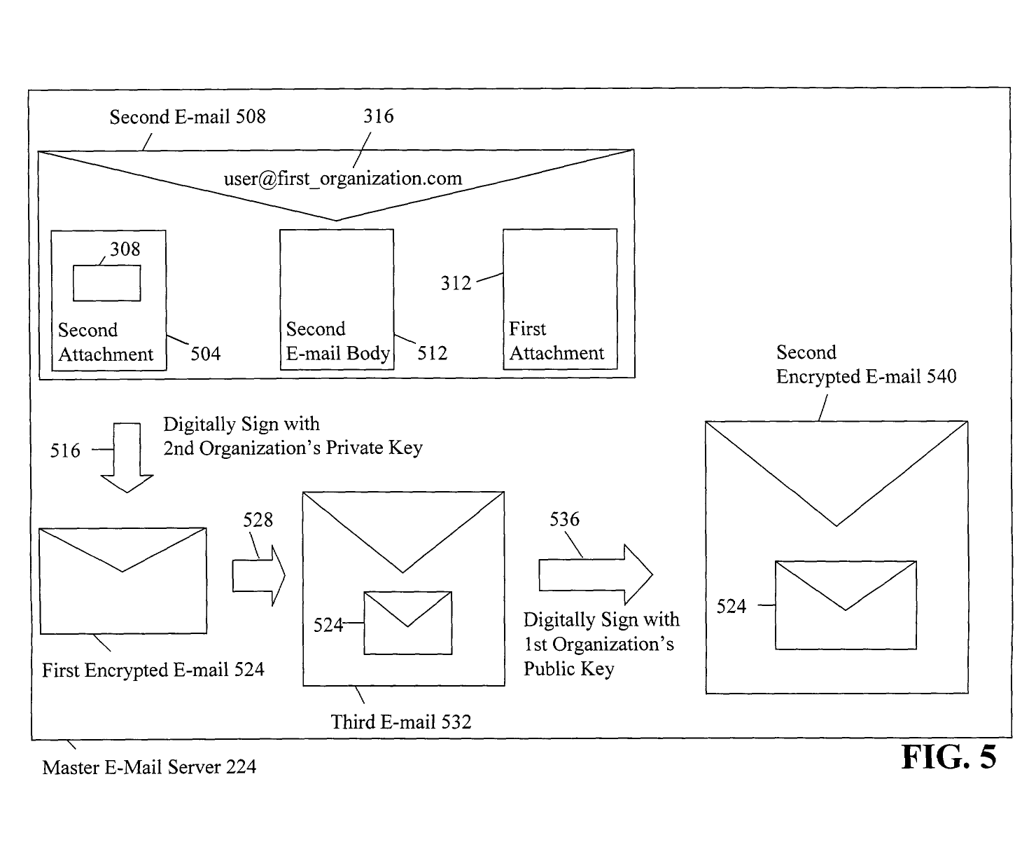

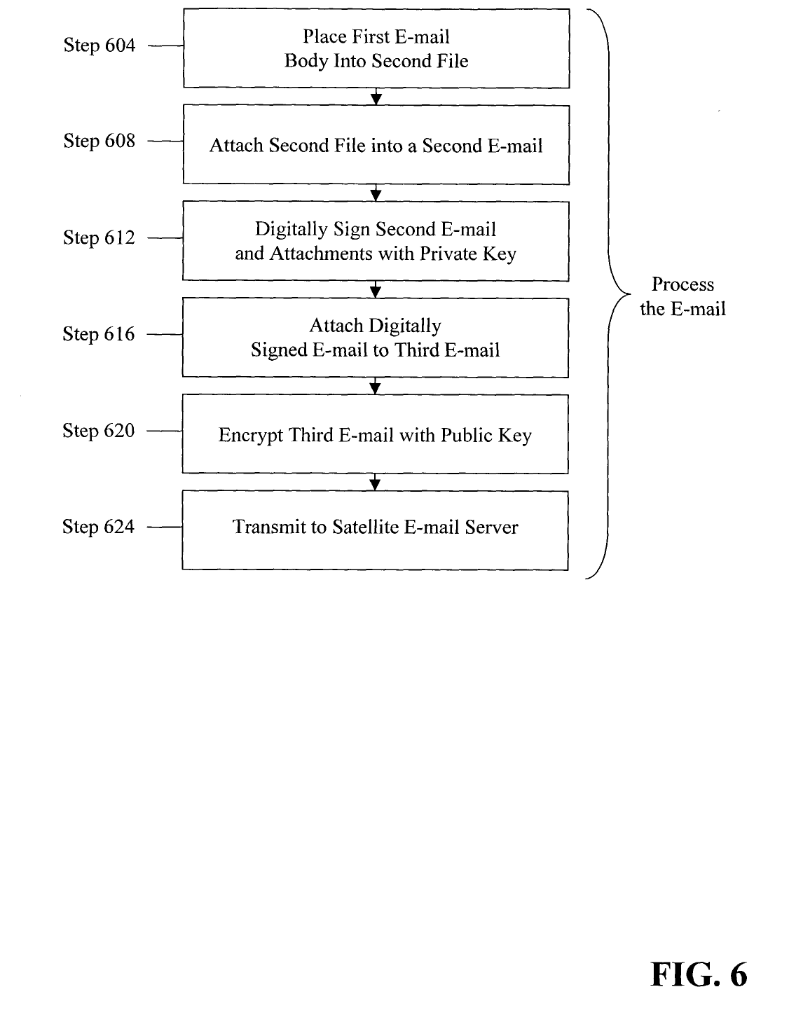

Referring to FIG. 5 and FIG. 6, the master e-mail server 224 then processes the message 304. The processing includes placing the first e-mail body 308 into another, second attachment or file 504 (STEP 604). The second file 504 may be a graphical file, textual file, e-mail, sound file, or any other file that can be transmitted across the network 112. The master e-mail server 224 then attaches the second file 504 to a second e-mail 508 (STEP 608). In one embodiment, the master e-mail server 224 generates a second e-mail body 512 for the second e-mail 508, such as text stating that the second e-mail 508 is delivered from the master e-mail server 224. Further, the second e-mail 508 also includes the first attachment 312 that the user wants to send to the recipient address 316. The master e-mail server 224 then digitally signs the second e-mail message 508 and the attachments 312, 504 with the second organization's private encryption key, as shown with arrow 516 (STEP 612).

In particular, the master e-mail server 224 can communicate with a certification authority (CA) to receive a secure digital certificate. The CA verifies the identity of the master e-mail server 224 and then issues the certificate. The certificate is digitally signed by the CA, thereby providing authenticity. The certificate has two components—a public key and a private key. The public key is available to anyone and can be used to verify information received from the master e-mail server 224. The private key is supposed to remain private so that the certificate remains trustworthy.

To send secure e-mail messages to the satellite e-mail server 212, the master e-mail server 224 can use the Secure Multi-Purpose Internet Mail Extensions (S/MIME) protocol. The S/MIME protocol can support the encryption of messages and the application of digital signatures via the certificate. Moreover, S/MIME digital signatures are applied to the entire e-mail message 508, including the e-mail body 512 and the attachments 312, 504. The digital signing with the second organization's encryption key creates a first encrypted e-mail 524.

In another embodiment, if the master e-mail server 224 determines that the recipient of the second e-mail 508 (e.g., the desktop 220) does not have the capability to verify the digital signature (e.g., cannot obtain the public key of the second organization), the master e-mail server 224 attaches a digital signature to the e-mail message, such as in a MIME file (e.g., smime.p7s). The presence of this file does not prevent or impede the user's ability to view the contents of the e-mail 508.

As shown with arrow 528, the master e-mail server 224 then attaches the first encrypted e-mail 524, including the first and second attachments 312, 504, to a third e-mail message 532 (STEP 616). The master e-mail server 224 then encrypts the third message 532 with the first organization's public key, as shown with arrow 536, to create a second encrypted e-mail 540, or final encrypted message (STEP 620). The master e-mail server 224 then transmits the second encrypted e-mail 540 to the first organization's satellite e-mail server 212 over the network 112, as shown with arrow 272 in FIG. 2 (STEP 624).

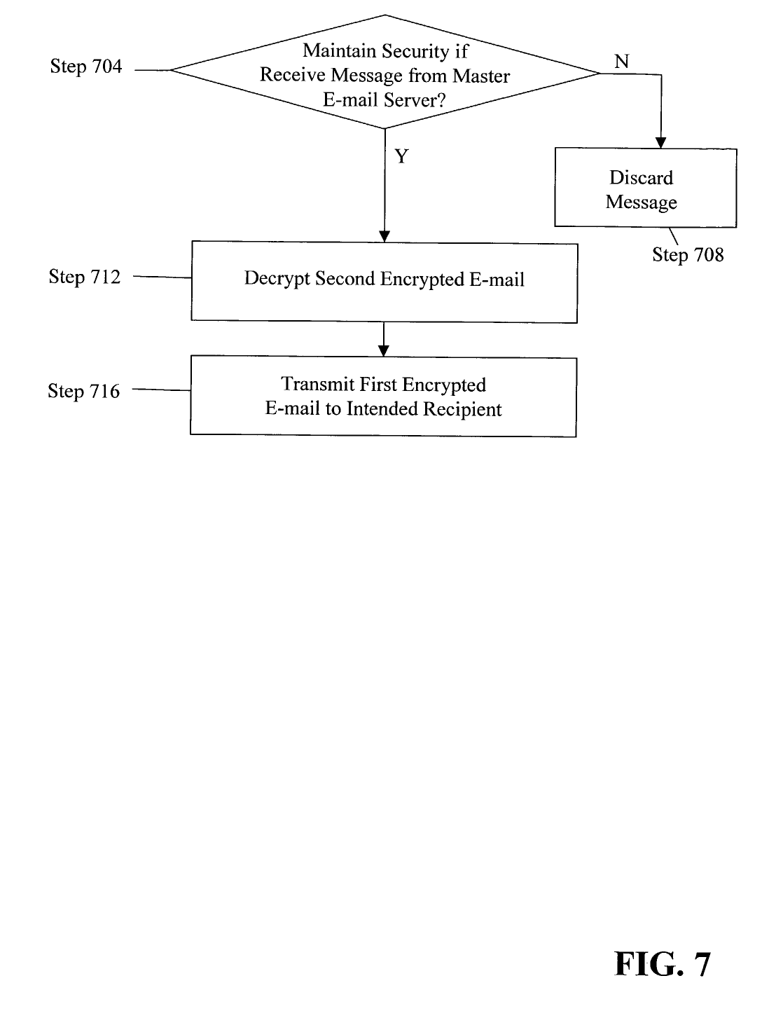

Referring to FIG. 7, the first organization's satellite e-mail server 212 receives the second encrypted e-mail 540 and determines whether it can receive messages from the second organization's master e-mail server 224 (STEP 704). For example, the satellite e-mail server 212 may check its configuration file to determine the address the satellite e-mail server 212 can receive messages from to maintain security.

If the satellite e-mail server 212 cannot receive messages from the master e-mail server 224, then the satellite e-mail server 212 discards any received message (STEP 708). If, however, the satellite e-mail server 212 determines that it can receive messages from the second organization's master e-mail server 224, the satellite e-mail server 212 decrypts the second encrypted e-mail 540 (STEP 712). Because the master e-mail server 224 encrypted the third e-mail 532 using the first organization's public key, the satellite e-mail server 224 decrypts the second encrypted e-mail 540 using its private key. Therefore, assuming that the private key of the satellite e-mail server 224 is secure and confidential (i.e., only the satellite e-mail server 224 “knows” the private key), the second encrypted e-mail 540 can only be decrypted by the satellite e-mail server 224. The server 212 then extracts the first encrypted e-mail 524 and transmits the e-mail 524 to the first organization's corporate e-mail server 216 over the main client-router communication channel 146 and the second client-router communication channel 143 (shown with arrow 258 in FIG. 2). The corporate e-mail server 216 performs its normal operations when receiving the first encrypted e-mail 524, such as scanning for viruses. The corporate e-mail server 216 then examines the recipient address of the first encrypted e-mail 524 and subsequently delivers the e-mail 524 to the user operating the desktop 220 over the main client-router communication channel 146 and the third client-router communication channel 144 (shown with arrow 262 in FIG. 2) (STEP 716).

The desktop 220 receives the first encrypted e-mail 524. The desktop 220 then verifies the digital signature of the first encrypted e-mail 524. Because the master e-mail server 224 encrypted the second e-mail 508 with the second organization's private key, the desktop 220 needs the second organization's public key to decrypt the first encrypted e-mail 524. This key is public and typically available to anyone. Therefore, the desktop 220 obtains the public key of the second organization and uses this public key to extract the second e-mail 508 from the first encrypted e-mail 524.

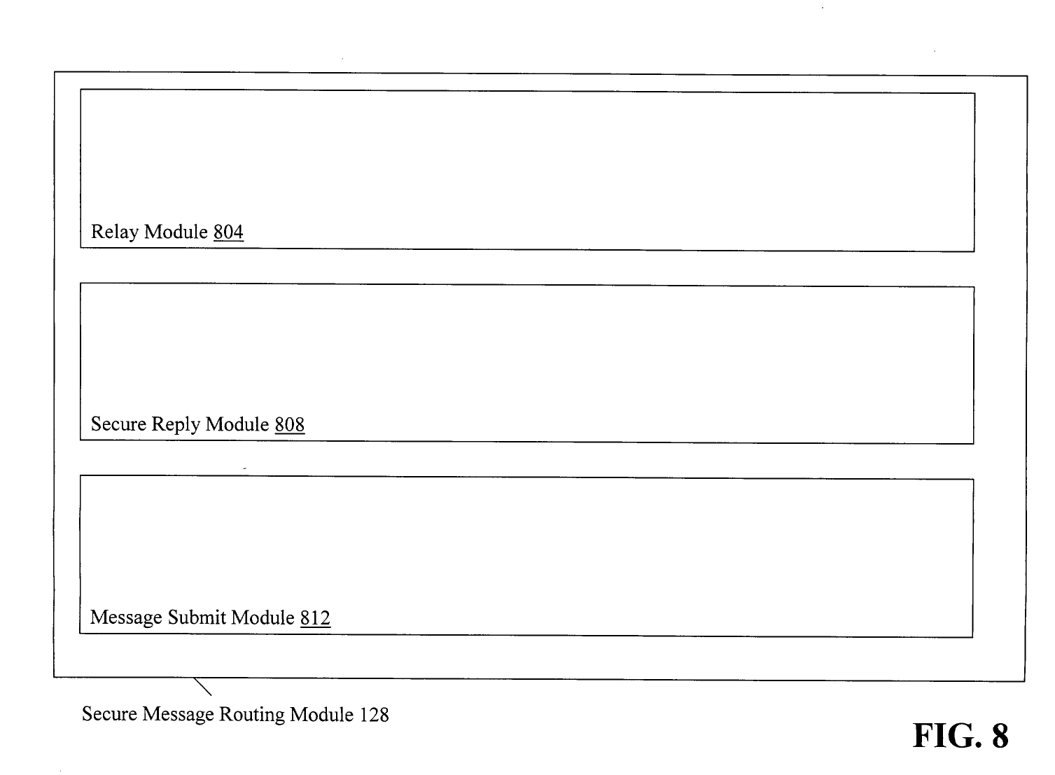

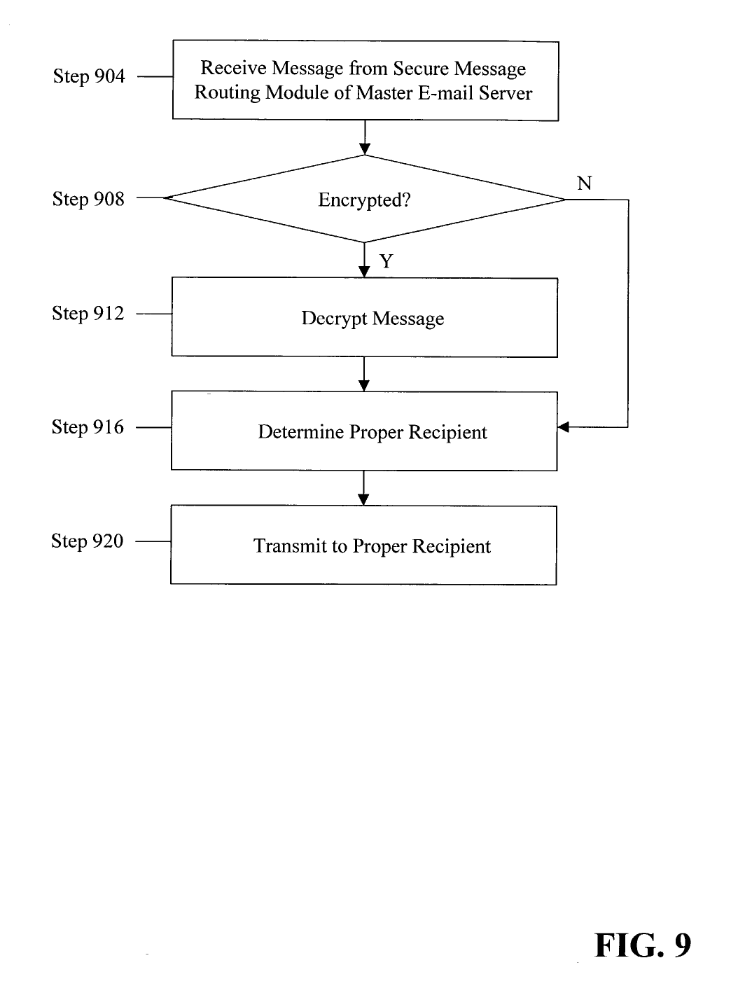

In more detail about the satellite e-mail server's processing of messages upon receipt and referring to FIG. 8 and FIG. 9, the secure message routing module 128 of the satellite e-mail server 212 includes a relay module 804, a secure reply module 808, and a message submit module 812. The relay module 804 enables the secure message routing module 128 to receive secure, encrypted messages from the master e-mail server 224, such as the second encrypted e-mail 540 (STEP 904). Upon receipt, the relay module 804 attempts to determine the intended recipient, such as the desktop computer 220, of the message 540. Thus, the relay module 804 determines if the secure message routing module 160 of the master e-mail server 224 encrypted the second encrypted e-mail 540 before transmitting it (STEP 908).

If the master e-mail server 224 encrypted the message 540, the relay module 804 decrypts the second encrypted e-mail 540 (STEP 912). The relay module 804 then determines that the desktop 220 is the intended recipient of the third e-mail 532 (STEP 916). Once this is determined, the relay module 804 transmits the third e-mail 532 to the corporate e-mail server 216 for subsequent processing before the message's transmission to the desktop 220 (STEP 920). Thus, the secure message routing modules 128, 160 enable a message to be communicated securely without the recipient user having to perform any additional steps relative to the normal steps taken to send and receive a message.

The secure reply module 808 enables the secure communication of a reply to the second encrypted e-mail 540 that the master e-mail server 224 sent. For example, upon receipt of the second encrypted e-mail 540, the secure reply module 808 can format the “REPLYTO” field of a response e-mail message. When the user of the desktop 220 replies to the second e-mail 508 (e.g., after the second encrypted e-mail 540 and the first encrypted e-mail 524 are decrypted), the desktop 220 sends the response e-mail to the corporate e-mail server 216. The corporate e-mail server 216 determines that the recipient of the response e-mail is the master e-mail server 224 and therefore communicates the response e-mail to the satellite e-mail server 212. In one embodiment, the corporate e-mail server 216 of the first organization is configured to recognize messages with particular recipient addresses (e.g., the master e-mail server 224) and, based on these addresses, send the message to the satellite e-mail server 212 before transmission. Likewise, the corporate e-mail server 228 of the second organization may also be configured to recognize messages with particular recipient addresses (e.g., the satellite e-mail server 212) and, based on these addresses, send the message to the master e-mail server 224 before transmission.

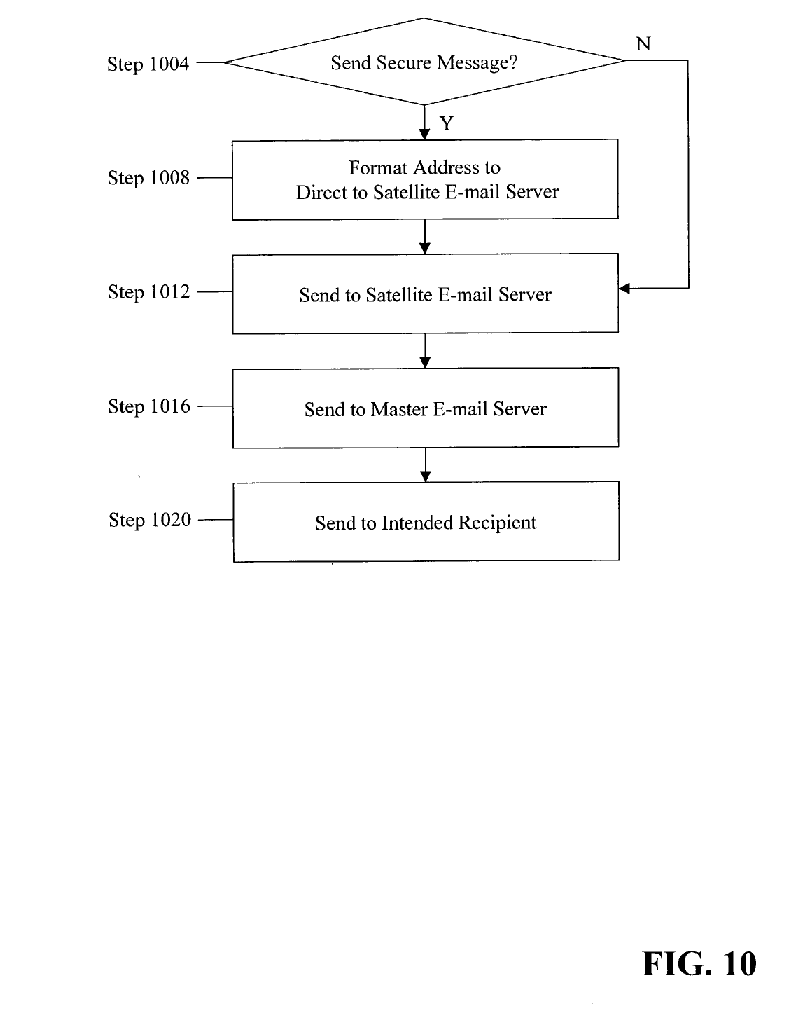

Also referring to FIG. 10, the message submit module 812 enables a user of the desktop 220 to send a new message to a recipient while the new message is sent to the master e-mail server 224 first before transmitting to the final recipient (STEP 404). The intended recipient can be anyone with an e-mail address. Thus, the intended recipient does not have to be part of the first organization's network 204 or the second organization's network 208 (i.e., no access to a secure message routing module 128, 160). If a user is operating the desktop 220 and wants to transmit a secure e-mail message to another recipient but also wants the master e-mail server 224 to process the message, the desktop 220 (i.e., the user) has to format the e-mail message so that the corporate e-mail server 216 transmits the message to the satellite server 212 rather than directly to the recipient (STEP 1008). Once the user (or desktop computer 220) inserts the special address format on an e-mail, the desktop computer 220 then transmits the message to the corporate e-mail server 216. The corporate e-mail server 216 reviews the address and determines that the message has a special address format. This special address format directs the corporate e-mail server 216 to transmit the message to the satellite e-mail server 212 for additional processing rather than transmitting it directly over the network 212 to the proper recipient (STEP 1012). The satellite e-mail server 212 then transmits the message to the master e-mail server 224 (STEP 1016). Once the master e-mail server 224 receives the message over the client-server communication channel 152, the master e-mail server 224 processes the message (e.g., provides security to the message by encrypting the message), and then directs the message to the intended recipient (STEP 1020).

The relay module 804, secure reply module 808, and message submit module 812 may be software programs executing on the secure message routing module 128. Alternatively, the modules 804, 808, 812 may be settings or features of the secure message routing module 128, thereby enabling a user or administrator of the satellite e-mail server 212 to configure the operation of the client 104. Additionally, any combination of the relay module 804, the secure reply module 808, and the message submit module 812 can be activated or set, enabling some or all of these features for a particular satellite e-mail server 212, for a particular user, or for a particular time period.

The secure message routing system 100 can be used in many fields, operations, organizations, and preferences. For instance, health care organizations process and manage many documents during their care of patients. These documents can include confidential information relating to their patient(s). Because of such information, the documents have to be properly secured when the health care organizations process the documents electronically. Moreover, health care organizations typically use e-mail as a way to communicate with patients or other medical professionals or organizations, such as hospitals, doctors, and/or insurance providers.

Further, as a health care organization expands, the demands placed on the organization increase. The increase in demands converts to the treatment of more patients and, consequently, the health care organization has to process additional documents. Moreover, legislation can place additional restrictions on the way health care organizations communicate. For example, the Health Insurance Portability and Accountability Act (HIPAA) states that the health care organizations have to put sufficient safeguards in place when communicating. If a health care organization communicates with a patient or organization over the network 112 without appropriate protections, the organization is not complying with the Act. Furthermore, noncompliance may result in financial loss, reduced patient trust, loss of integrity, and harm to an organization's reputation. Therefore, the secure message routing system 100 can provide the requisite security needed by a health care organization to communicate over the network 112. Moreover, the secure message routing system 100 provides this security without the need to train the medical professionals and without relying on the medical professionals to enable this type of security. Instead, the medical professionals follow their usual practices when sending or receiving messages, while obtaining the security benefits provided by the secure message routing system 100.

The secure message routing system 100 can also benefit other fields. For example, the legal community views the security of its communications as a high concern. Typically, law firms transmit to and receive from its clients confidential information associated with a particular case. Maintaining the security of these transmissions may be imperative to retaining the client's business, as a security breach may ruin the client's chances of success at trial. Moreover, communications between a government agency and a development contractor or between a financial institution and a large institutional investor also often benefit, and sometimes require, security when communicating over a network 112. Thus, the secure message routing system 100 can provide the security benefits to organizations without any training needed for an organization's employees. Moreover, the risk of a user failing to perform a particular action, such as the toggling of a software switch (e.g., check box), is minimized, as the security features are implemented automatically.

Having described certain embodiments of the invention, it will now become apparent to one of skill in the art that other embodiments incorporating the concepts of the invention may be used. Therefore, the invention should not be limited to certain embodiments, but rather should be limited only by the spirit and scope of the following claims.

What is claimed is:

1. A method for securely communicating a message between a first communication module and a second communication module, the method comprising the steps of:
(a) receiving, by the first communication module, a first message generated by a user; and
(b) automatically encrypting the first message to create a final encrypted message so that only the second communication module can decrypt the final encrypted message,
wherein the automatic encryption is transparent to the user.

2. The method of claim 1, wherein the first message is an e-mail message.

3. The method of claim 1, further comprising the step of transmitting the first message to the first communication module in response to a rule associated with an address of the first message.

4. The method of claim 3, further comprising the step of comparing the address of the first message with a list of addresses.

5. The method of claim 1, further comprising the step of creating a second message having the first message embedded therein.

6. The method of claim 5, further comprising the step of digitally signing the second message to create a first encrypted message.

7. The method of claim 6, further comprising the step of generating a third message having the first encrypted message embedded therein.

8. The method of claim 7, further comprising the step of digitally signing the third message to create a final encrypted message.

9. The method of claim 1, further comprising the step of transmitting the final encrypted message to the second communication module.

10. The method of claim 1, wherein the encryption occurring transparent to the user occurs with an absence of any additional activity of the user besides normal activity for sending a message to the second communication module.

11. The method of claim 1, further comprising the step of decrypting the final encrypted message before delivering to a recipient.

12. The method of claim 11, wherein the decryption is transparent to the recipient.

13. An apparatus for securely communicating a message comprising:
(a) a first communication module receiving a first message generated by a user;
(b) a first secure message routing module in communication with the first communication module to automatically encrypt the first message to create a final encrypted message so that only a particular receiver of the final encrypted message can decrypt the final encrypted message,
wherein the automatic encryption is transparent to the user.

14. The apparatus of claim 13, wherein the first communication module is a master e-mail server.

15. The apparatus of claim 13, further comprising a second secure message routing module in communication with the first secure message routing module.

16. The apparatus of claim 15, wherein the particular receiver is the second secure message routing module.

17. The apparatus of claim 15, further comprising a corporate e-mail server directing the first message to the first communication device based on a predetermined criteria.

18. The apparatus of claim 17, wherein the corporate e-mail server comprises an address table for determination of whether to direct the first message to the first communication device.

19. The apparatus of claim 15, wherein the second secure message routing module further comprises a relay module enabling the second secure message routing module to receive the final encrypted message from the first communication module.

20. The apparatus of claim 15, wherein the second secure message routing module further comprises a secure reply module enabling sending a secure reply message to the first communication module in response to the final encrypted message.

21. The apparatus of claim 15, wherein the second secure message routing module further comprises a message submit module enabling a new message addressed to a recipient to be transmitted to the first communication module for security processing before transmitting to the recipient.

22. The apparatus of claim 15, wherein at least one of the first message and the final encrypted message comprises an e-mail.

23. The apparatus of claim 13, wherein the user comprises at least one of a computer and a person in communication with the first communication module.

24. A method for securely communicating a message between a first communication module and a second communication module, the method comprising the steps of:
(a) receiving, by the second communication module, a final encrypted message transmitted by the first communication module; and
(b) automatically decrypting the final encrypted message to obtain a first message addressed to a user,
wherein the automatic decryption is transparent to the user.

25. A method for securely communicating a message between a first communication module and a second communication module, the method comprising the steps of:
(a) receiving, by the first communication module, a first encrypted message sent by a first user in communication with the second communication module;
(b) receiving, by the first communication module, a second message generated by a second user in communication with the first communication module;
(c) automatically decrypting the final encrypted message to obtain a first message addressed to the second user; and
(d) automatically encrypting the second message to create a second encrypted message so that only the second communication module can decrypt the second encrypted message,
wherein the automatic encryption is transparent to the first user and the second user, and
wherein the automatic decryption is transparent to the first user and the second user.

26. An apparatus for securely communicating a message between a first communication module and a second communication module comprising:
(a) means for receiving, by the first communication module, a first message generated by a user; and
(b) means for automatically encrypting the first message to create a final encrypted message so that only the second communication module can decrypt the final encrypted message,
wherein the means for automatic encryption is transparent to the user.
